(19) United States
(12) Patent Application Publication
(10) Pub. No.: US 2005/0251922 A1
(43) Pub. Date: Nov. 17, 2005

(54) Method for shaping animal hide

(76) Inventor: Lidia Amirova, Brooklyn, NY (US)

Correspondence Address: Ross J. Christie, Esq.;Law Office of Ross J. Christie, LLC, 36 Mill Plain Road, Suite 203, Danbury, CT, 06811-5111, US

(21) Appl. No.: 10/844,853

(22) Filed: May 13, 2004

(51) Int. Cl. C14C 1/00

(52) U.S. Cl. 8/94.15

(57) ABSTRACT

A method for shaping animal hide may generally comprise the steps of wetting an animal hide, chemically treating the animal hide and then shaping the animal hide to the desired form. Once the animal hide is wetted and chemically treated, the hide becomes malleable, that is, adaptable and manually manipulable. The wetting and chemical treatment steps may be repeated as the animal hide becomes stiff. The flexible, malleable animal hide may then be manually manipulated to the desired shape.

### FIELD OF THE INVENTION

This disclosure relates to shaping animal hide, and more particularly, to methods for shaping animal hide to form fashion apparel and works of art.

### BACKGROUND

The fashion world is constantly experiencing flux as couture and avant-garde enter the mainstream consumer market. The fashion designers desire fresh and unique approaches to creating fashion apparel, while fashion conscience consumers desire sophisticated and unique approaches to clothing designs, novel materials and the up-to-the-moment fashion trends.

Animal hide is a commonly used material in manufacturing clothing. However, animal hide cannot retain its form unless the hide is stitched or punched. For example, cobbling, or the art of shoemaking, involves stitching soft, thin animal hide to manufacture shoes. Soft, thin leather cannot otherwise be held together and worn on a person's foot. Stitching animal hide may effectively retain the desired shape but the hide itself may in turn become marred or damaged during the process. Punching generally involves fitting a rubber mold with an animal hide, heating the animal hide, applying pressure to the heated animal hide, and shaping the animal hide to conform to the mold. The punched animal hide will then retain the mold's shape. The time and labor involved to create the initial rubber mold are high and make this process inefficient for manufacturing garments having certain features. Features such as lapels, cuffs, pleats and the like are too difficult to incorporate into such molds, and thus punching is not a desirable method.

In addition, other industries employ animal hides as well. For example, milliners employ animal hides to manufacture women's hats. Artists also sometime employ animal hides to create their works of art. The historical methods of stitching and punching for the reasons already mentioned may not be the most desirable or successful manufacturing technique.

Accordingly, there exists a need for a method for shaping animal hide that allows a designer of fashion apparel and accessories to incorporate certain garment features without incurring additional time, labor and costs, or an artist to create works of art without adulterating the starting material.

### SUMMARY

The above-mentioned drawbacks and disadvantages are overcome or alleviated by a method for shaping animal hide comprising wetting a natural hide side of an animal hide; chemically treating a substantially wetted natural hide side of the animal hide; and shaping the animal hide.

These and other features, aspects and advantages of the exemplary methods described herein will become better understood with reference to the following drawings, description and claims.

### BRIEF DESCRIPTION OF THE DRAWINGS

For a further understanding of the nature of the present invention, as well as other features and advantages thereof, reference should be made to the following detailed description taken in conjunction with the accompanying figures, which are meant to be exemplary, not limiting, and wherein:

FIG. 1 is a photograph of a front view of a sculpture made of cowhide created using the exemplary embodiments of the method described herein;

FIG. 2 is a photograph of a side view of the sculpture of FIG. 1;

FIG. 3 is a photograph of a side view of a bracelet made of alligator hide created using the exemplary embodiments of the method described herein;

FIG. 4 is a photograph of a perspective view of the bracelet of FIG. 3;

FIG. 5 is a photograph of a perspective view of a bodice made of alligator hide created using the exemplary embodiments of the method described herein;

FIG. 6 is a photograph of a side view of the bodice of FIG. 5;

FIG. 7 is a photograph of a perspective view of a hat made of alligator hide created using the exemplary embodiments of the method described herein;

FIG. 8 is a photograph of a front view of the hat of FIG. 7;

FIG. 9 is a photograph of a front view of a corset of a dress made of cowhide created using the exemplary embodiments of the method described herein;

FIG. 10 is a photograph of a perspective view of the corset of FIG. 9;

FIG. 11 is a photograph of a front view of a dress made of alligator hide created using the exemplary embodiments of the method described herein; and

FIG. 12 is a photograph of a rear view of the dress of FIG. 11.

### DETAILED DESCRIPTION

The following detailed description is of the best currently contemplated modes of carrying out the invention. The description is not to be taken in a limiting sense, but is made merely for the purpose of illustrating the general principles of the invention, since the scope of the invention is best defined by the appended claims.

The exemplary embodiments of the present method may generally be useful in the context of designing fashion apparel and creating sculptures using animal hide. Once shaped, animal hide is a material that cannot retain its form unless the hide is stitched, e.g., cobbling shoes, or punched, e.g., heat and pressure treated to conform to a mold and retain its shape. Until now, fashion apparel designs utilizing animal hide had to incorporate stitching in order to create certain garment features, e.g., pleats, lapels, cuffs and the like. Such garment features are too difficult to create using the punch method. Creating a mold to incorporate such garment features is time and labor intensive, increases costs and is inefficient in light of existing garment alteration methods. The exemplary embodiment of the present method of shaping animal hide alleviates the need for the labor intensive and time consuming punch method. Moreover, the exemplary embodiments of the present method also achieve shaping various garment features using animal hide without adulterating the hide with stitching.

The exemplary embodiments of the methods described herein may be used to manufacture fashion apparel and works of art. Fashion apparel includes but is not limited to any garment or article of clothing as well as any accessories to be worn such as but not limited to gloves, jewelry, shoes, belts and the like. Works of art comprise any objects used for interior designing or interior decorating, any objects intended to beautify an area and/or generate an aesthetic aura, and any objects created with intention of being, becoming or existing as art work.

An exemplary embodiment of a method for shaping animal hide may generally comprise the steps of wetting an animal hide, chemically treating the animal hide and then shaping the animal hide to the desired form. Once the animal hide is wetted and chemically treated, the hide becomes malleable, that is, adaptable and manually manipulable. As time passes, the wetting and chemical treatment steps may be repeated as the animal hide becomes stiff and semi-dry areas, that is, drying, or substantially dry areas, that is, nearly dry or completely dry, form. The flexible, malleable animal hide may then be manually manipulated to the desired shape.

Raw hides are the raw materials used to produce animal hides, or finished leather. A raw hide's external appearance and organic characteristics are influenced and affected by many factors including but not limited to the animal's size, general health and origin, that is, labored, penned, wild, and the like, as well as scratches, scars, damage caused by parasites or barbed wire fencing, and the like. Raw hides are tanned in order to make the hide decay proof. Once tanned, the hides may be dyed using one or more dyeing methods known in the art, prior to being finished. Finishes are coverings that deposit on the surface leaving a film of varying thickness. The hides are finished using a finishing method such as casein, resin, nitre, polyurethane, and the like.

With respect to the tanning step, the basic and most common types of tanning are chromium based and vegetable based. These two tanning methods create the various mixed tans commercially available in the market. For the exemplary embodiments of the present methods, thicker and heavier weighing hides are typically tanned using the chromium method, and thinner, lighter weighing hides are typically tanned using the vegetable method. Generally, chromium tanned hides possess compact fibers, have excellent tear resistance and are extremely elastic and return to their original shape when stretched. For example, crocodile hides and alligator hides are tanned using the chromium tan method due to the thickness, weight, rough natural epidermis, and other environmental and natural factors. Vegetable tanned hides do not have very compact fibers, are puffier and softer, are not very elastic and deform when stretched, have low tear resistance, and stain easily when wetted. For example, cowhides, deer hides and horse hides are tanned using the vegetable tan method due to their relatively lighter weight, softer natural epidermis, and other environmental and natural factors.

In the exemplary embodiments of the methods described herein, both vegetable tan and chromium tan hides may be employed. Vegetable tanned animal hides possess a vegetable tan side and a finished side. The vegetable tan side is soft, unfinished, possibly rough, and receptive to the wetting and chemical treatment applications described herein. The finished side, or the epidermis, may have a polished finish or a glossy finish, e.g., a patent leather finish. With regard to fashion apparel and artistic applications, any type of animal hide possessing a vegetable tan side and a finished side as known to one in the art may be utilized in the exemplary embodiments of the methods described herein. Chromium tanned animal hides possess a chromium tan side and a finished side. The chromium tanned side is rough, unfinished and also receptive to the wetting and chemical treatment applications described herein. The finished side, or the epidermis, may have a polished finish or a glossy finish, e.g., a patent leather finish. With regard to fashion apparel and artistic applications, any type of animal hide possessing a chromium tan side and a finished side as known to one in the art may be utilized in the exemplary embodiments of the methods described herein. Representative vegetable tan and chromium tan animal hides may include but are not limited to alligator hide, crocodile hide and related chromium tan animal hides, and cowhide, deer hide, horse hide and related vegetable tan animal hides, and the like. In the exemplary embodiments of the present methods described herein, both vegetable and chromium tanned hides sides of a piece of animal hide are generally referred to as the natural hide side of the animal hide.

Generally, both vegetable and chromium tan animal hides are classified by grades using many factors including but not limited to thickness and weight. Grades are generally ranked according to the following measurements: thicknesses of no more than about three (3) millimeters (“mm”) and weights of about one (1) ounce (“oz.”) to two (2) oz.; thickness of about one (1) mm to three (3) mm and weight of about one (1) oz. to about two (2) oz.; and, thicknesses of no less than about three (3) mm and weights of about one (1) oz. to two (2) oz. Generally, suitable weights of animal hides possessing the aforementioned thicknesses may comprise about 0.1 oz. to ten (10) oz., preferably about one (1) oz. to five (5) oz., and most preferably about one (1) oz. to about two (2) oz. Animal hides possessing a thickness of no more than about three (3) mm, and a weight of no more than about one (1) oz., or about 0.01 oz to one (1) oz., are typically soft and thin. Such, soft thin animal hides are suitable for shaping and creating artwork in accordance with the exemplary methods contemplated and described herein, but may not be suitable for shaping and creating fashion apparel as contemplated and described herein. Animal hides possessing a thickness of about three (3) mm to thicknesses of no less than about three (3) mm, and weights of about one (1) oz. to about two (2) oz., are suitable for shaping and creating both fashion apparel and artwork in accordance with the exemplary methods contemplated and described herein. Suitable cowhides may possess thicknesses of no more than about three (3) mm to thicknesses of no less than about three (3) mm and weights of about one (1) oz. to about two (2) oz., while suitable alligator hides generally possess a thickness of no less than about three (3) mm and weights of about one (1) oz. to about two (2) oz.

An exemplary embodiment of a method for shaping animal hide may generally comprise the steps of wetting a natural hide side of an animal hide, chemically treating the natural hide side of the animal hide and then shaping the treated animal hide to the desired form. The step of wetting may comprise applying a solution substantially comprising water, or preferably water only, to the natural hide side of an animal hide. Applying the solution can be achieved using one, or a combination of, the following methods: brushing, sponging, wiping, rubbing, pouring, toweling, swabbing, scrubbing, spraying, squirting, dripping, dipping and smearing. In certain desired applications, the natural side of the animal hide may be dipped into the solution substantially comprising water, or preferably water only, such that both sides of the animal hide are wetted. Preferably, only the natural side animal is wetted, as opposed to both sides. The wetting application may be accomplished using any number of applicator implements. Such applicator implements preferably possess non-abrasive applicator surfaces in order to transfer the solution to and effectively soak the natural hide side without marring or damaging the hide's natural beauty. Preferred applicator implements may include but are not limited to a sponge, brush, cloth, towel, swab, spray receptacle, squirt receptacle, pouring receptacle, dripping receptacle and the like.

In preparing to wet and soak the natural hide side of the animal hide, the solution substantially comprising water, or water only, is preferably maintained at an ambient temperature or warmed, e.g., warm to a person's touch, to achieve an ambient temperature. Wetting and soaking the natural hide side of the animal hide may comprise applying the solution with an applicator implement. The natural hide side absorbs the solution and becomes substantially wetted, e.g., semi-wet, wet, semi-saturated or saturated. Wetting and soaking does not imply or convey the partial or complete immersion of the natural hide side, or entire piece of animal hide, into a bath containing the solution. Once the natural hide side of the animal hide absorbs the solution and is substantially wetted, the substantially wetted natural hide side will be prepared to receive the chemical treatment.

The chemical treatment step may generally comprise applying a substantially chemical based solution to the substantially wetted animal hide side of the animal hide. The substantially chemical based solution may comprise a solid or liquid sizing composition or a similar composition possessing chemical properties comparable to a sizing composition. In the alternative, the chemical treatment step may comprise applying a substantially chemical based gaseous sizing composition to the substantially wetted animal hide side of the animal hide. Sizing compositions are typically employed in paper manufacturing and dry cleaning. Suitable sizing compositions for use in the present exemplary methods described herein are known in the art and commercially available in the dry cleaning industry. For example, commercially available suitable sizing compositions include but are not limited to Star Bright® Liquid II Sizing from Faultless Starch Company and Bon Ami of Kansas City, Mo.; Revital® from KO Manufacturing of Springfield, Mo.; Vivisize® from the Stamford® Division of Fabritec International of Cold Springs, Ky.; Fabritec 5502 from Fabritec International; and, Klean 'N Size, B.D.S., Spray Sizing Aerosol and Injectable Sizing all from Laidlaw Corporation of Metropolis, Ill. Sizing compositions are generally known in the art as “sizing”, and future references made throughout the description to sizing specifically refer to sizing compositions.

Sizing may comprise a solid, liquid or gas in a petroleum based carrier or hydrocarbon resin based carrier. A solid sizing may comprise a bead form or powder form sizing, and solvent in or able to be dissolved, suspended, mixed with or by a petroleum based or hydrocarbon resin based carrier or solution. A liquid sizing may comprise a liquid sizing alone, or a combination of a liquid sizing and a petroleum based carrier or a hydrocarbon based carrier. A gaseous sizing may comprise a sizing capable of being combined with a petroleum based carrier or hydrocarbon resin based carrier and suitable for dispersion by an aerosol. Petroleum based carriers and hydrocarbon resin based carriers may generally comprise petroleum naptha blends, and such petroleum naptha blends may comprise no less than about fifty percent (50%) by volume of the sizing.

In the chemical treatment step, the sizing is applied evenly over an area of the substantially wetted natural hide side. Chemically treating the natural hide side may be achieved using one, or a combination of, the following methods: brushing, sponging, wiping, rubbing, pouring, toweling, swabbing, scrubbing, spraying, squirting, dripping and smearing. Any number of applicator implements may be employed. Such applicator implements preferably possess non-abrasive applicator surfaces in order to effectively substantially wet the natural hide side without marring or damaging the hide's natural beauty. Preferred applicator implements may include but are not limited to a sponge, brush, and the like.

As the chemical treatment of the substantially wetted animal hide side progresses, the animal hide may lose flexibility and malleability, and become stiff as the animal hide begins drying. The animal hide may begin developing semi-dry areas, that is, drying, or substantially dry areas, that is, nearly dry or completely dry, as time passes during the chemical treatment step. In addition to time being a factor, the size of the animal hide also influences the formation of semi-dry and substantially dry areas. The larger the piece of animal hide being shaped, the more likely the animal hide will dry and form semi-dry and substantially dry areas during the chemical treatment step. The wetting step may be repeated as necessary to re-wet the semi-dry areas or substantially dry areas. As the wetting step is repeated, the chemical treatment step may also be repeated to the substantially wetted natural hide side in order to maintain the chemically treated animal hide's flexibility and malleability.

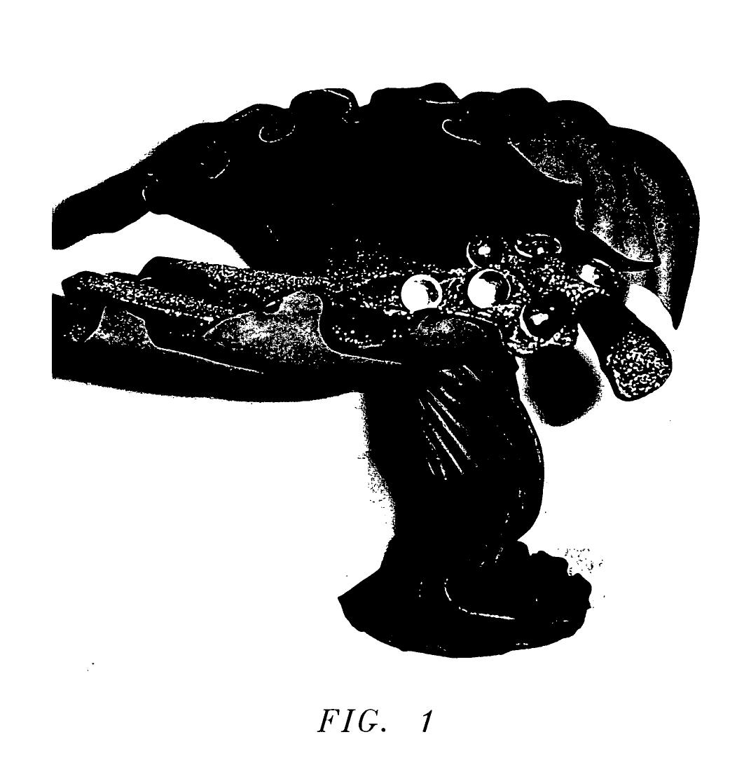

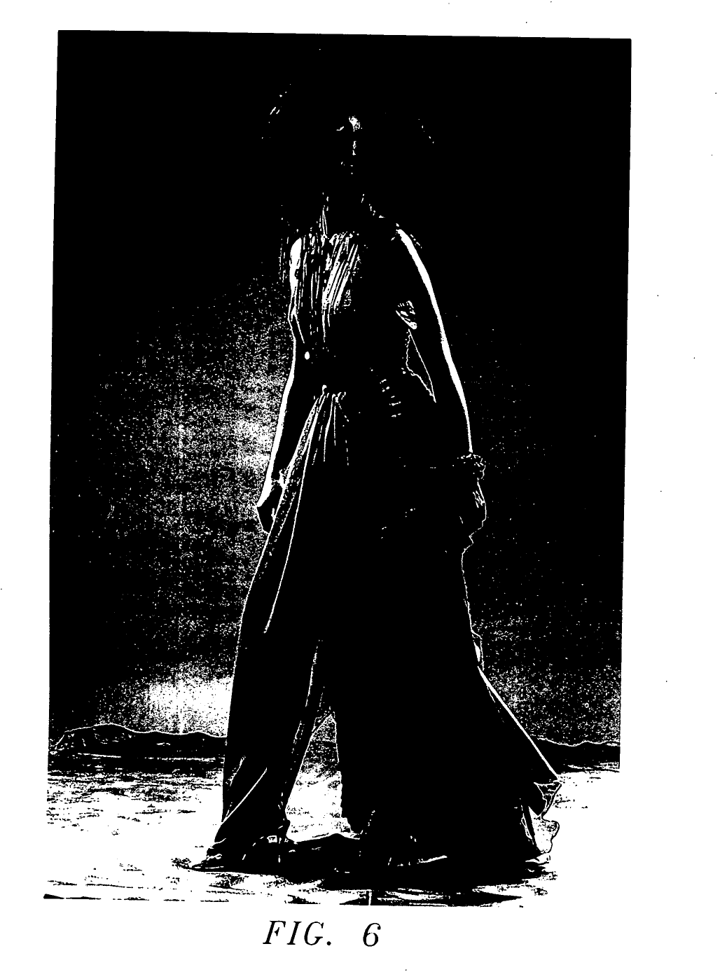

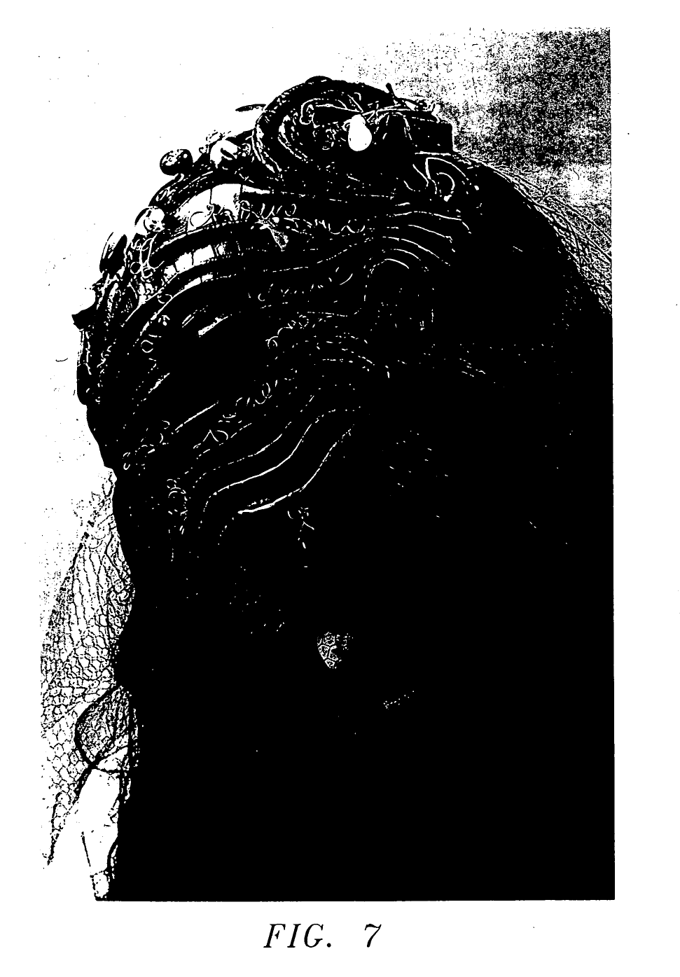

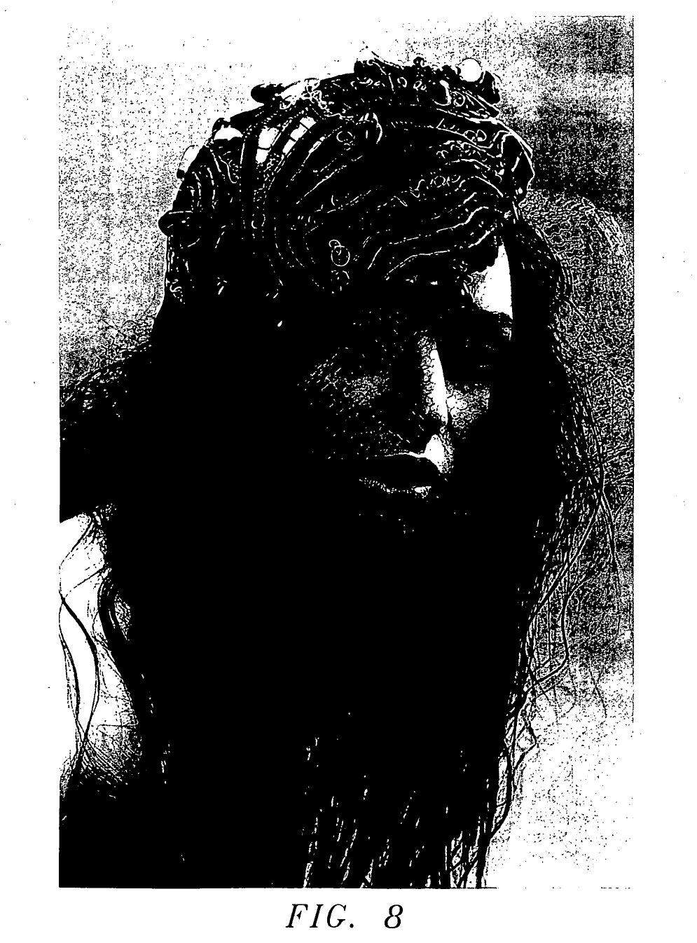

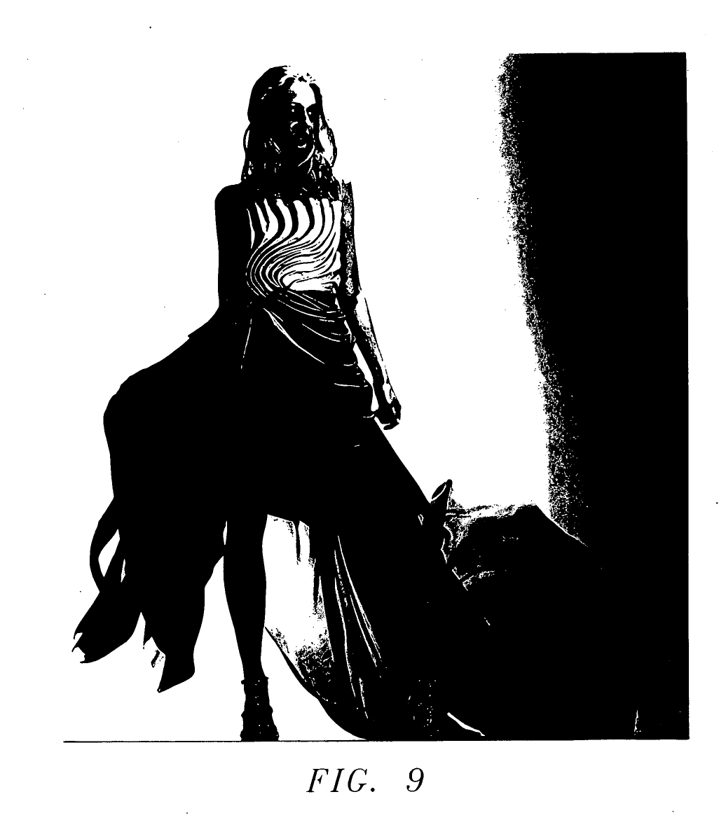

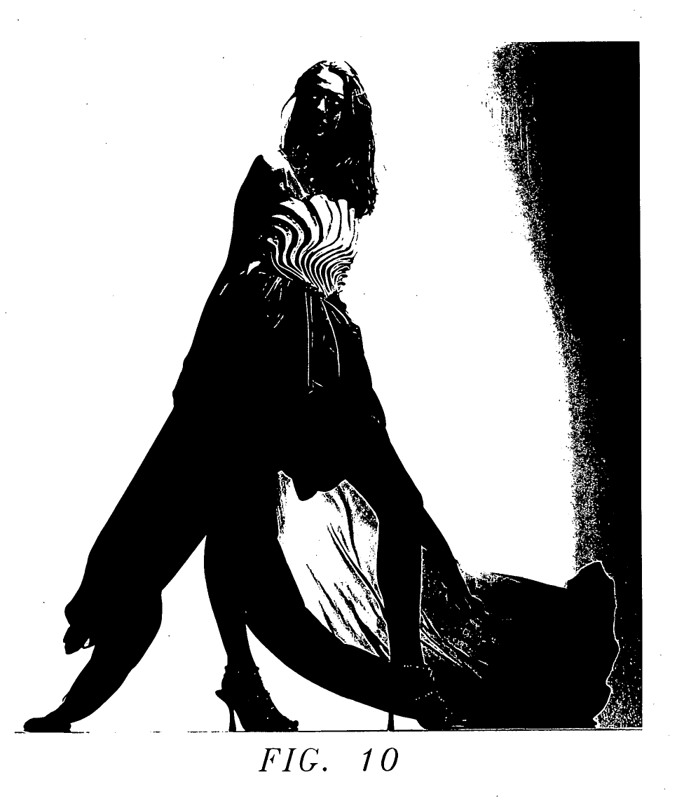

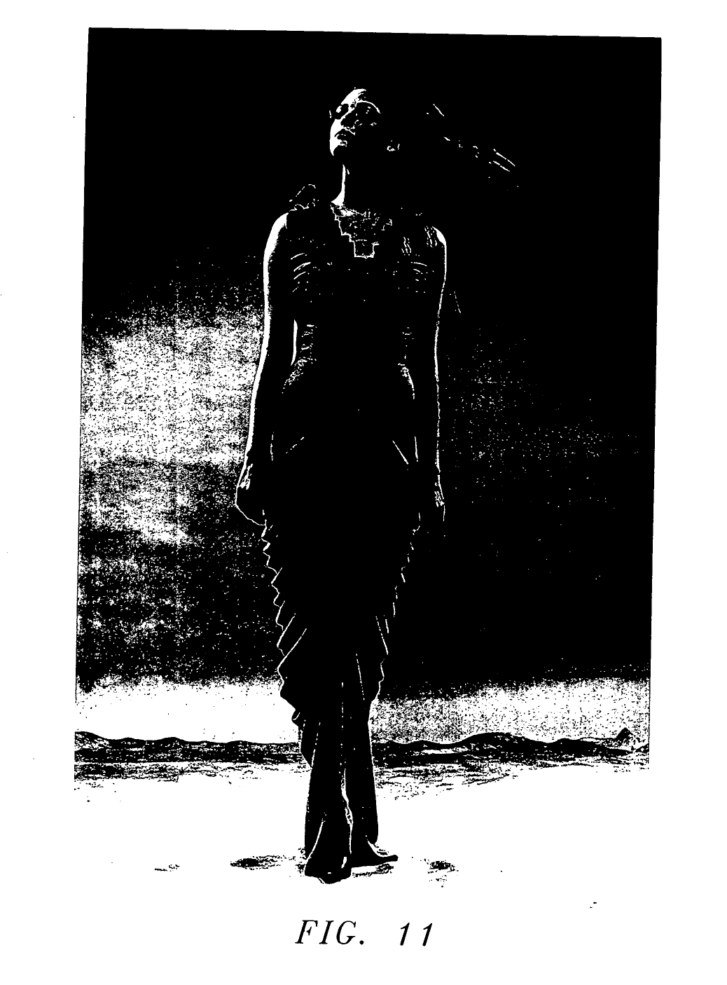

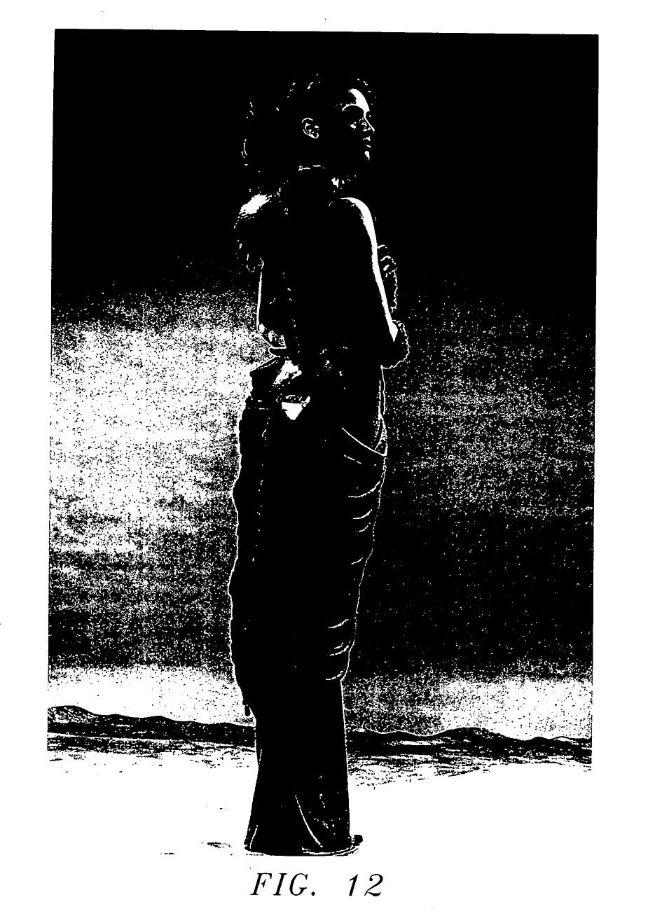

The flexible, malleable chemically treated animal hide may be manually manipulated and shaped to the desired form. The term “shaping” as used herein includes but is not limited to manual manipulating the treated animal hide with one's hands, as well as using any tool or object known by one of ordinary skill in the art or any tool or object of the creator's discretion that can effectively shape the treated animal hide to the desired form, including a machine or automated device as known by one of ordinary skill in the art capable of shaping the treated animal hide. When designing apparel and clothing, the chemically treated animal hide may be mounted to a mannequin or mannequin parts, e.g., an armature, a head form, and the like, and secured using pins. Once mounted, the chemically treated animal hide may be shaped and altered, e.g., cut, folded, pleated, and the like, to the desired design. Due to the typical heavy weight of an animal hide, and especially a wetted animal hide, the mannequin and/or mannequin parts utilized must be sturdy which excludes using any paper mache constructed mannequin and/or mannequin parts. The flexible, malleable chemically treated animal hide may also be manually manipulated and shaped for artistic purposes. In addition, as illustrated in the photographs of FIGS. 1 through 12, the fashion apparel and/or work of art may be adorned with one or more objects, or a plurality of objects, as desired. Such objects may include but are not limited to stones, precious stones, beads, pearls, flowers, sand, wires, chains, pins, other ornamental and/or decorative objects, and the like, as well as paint, finishes, coatings, other ornamental and/or decorative layered applications, and the like as desired.

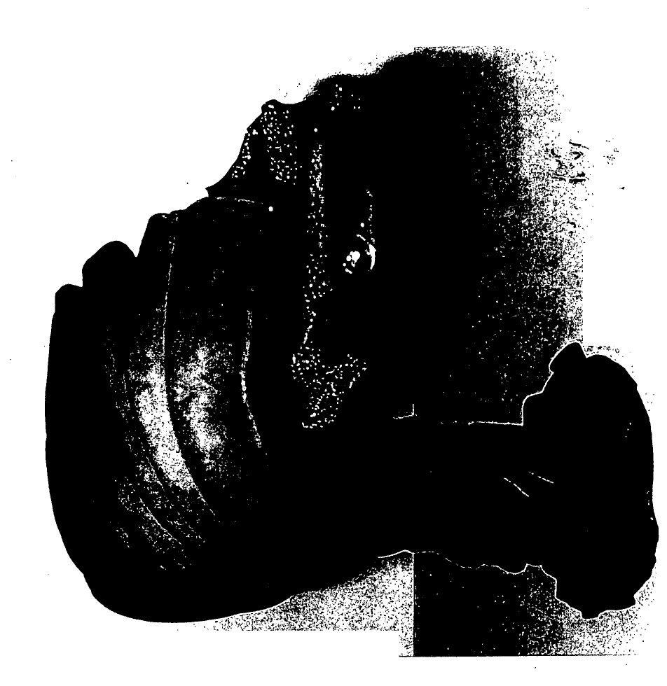

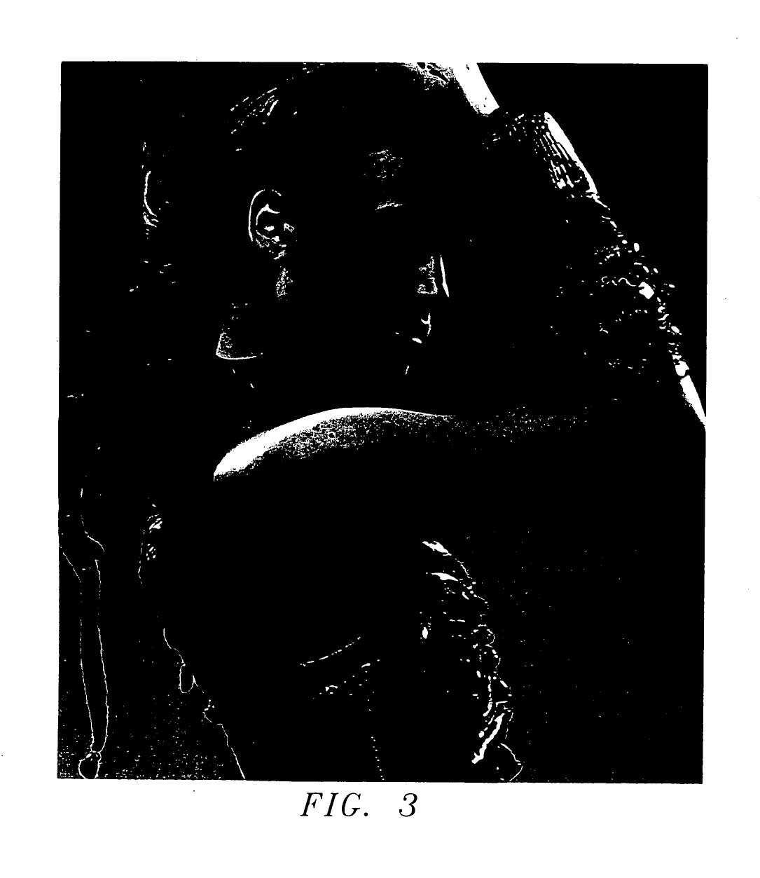

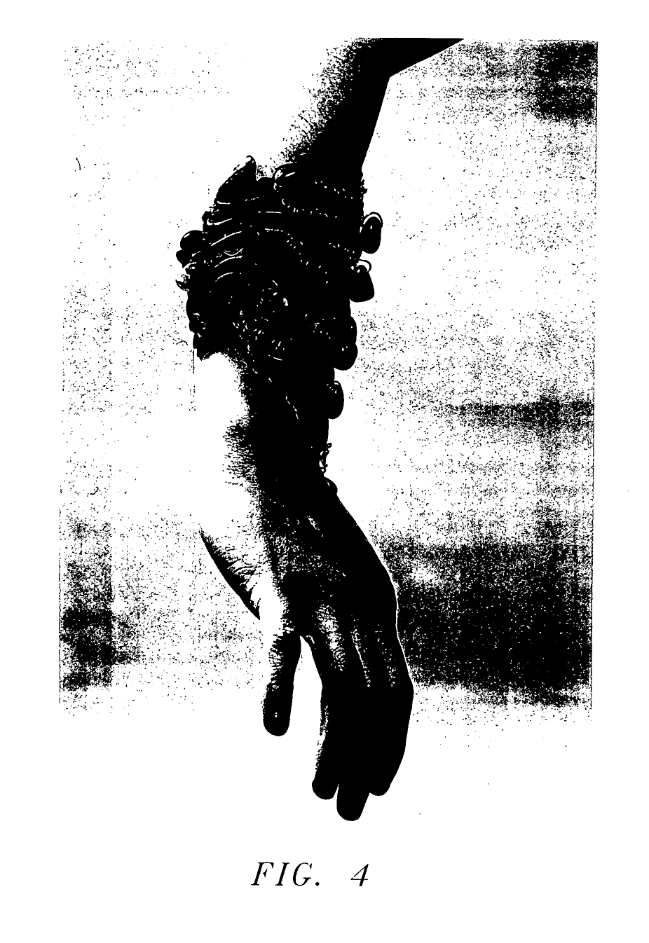

For example, FIG. 2 is a photograph of a bracelet created according to the method described herein wherein the alligator hide was mounted to an armature to ensure its resultant shape conformed to a person's arm. In another example, FIG. 4 is a photograph of a hat created according to the method described herein wherein the alligator hide was mounted to a head form to ensure its resultant shape conformed to a person's head. Likewise, the exemplary bodice, corset and dress shown in the photographs of FIGS. 3, 5 and 6 were all created employing the methods described herein as the respective animal hides were mounted to mannequin torsos and shaped accordingly.

In addition, when sculpting artwork, the chemically treated animal hide may be mounted to a sculpting base as is known in the art. Again, once mounted, the chemically treated animal hide may be shaped and sculpted to the desired object. As an example, the sculpture shown in the photograph of FIG. 1 was created using the method described herein wherein the animal hide was secured to a sculpting base and manually shaped to the desired form.

### EXAMPLE

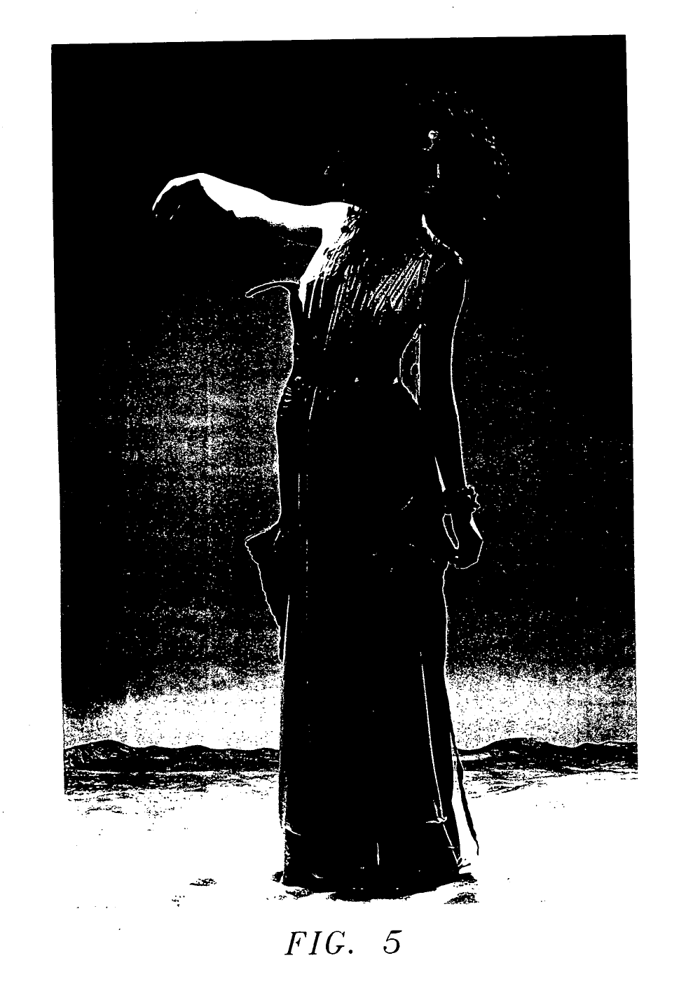

The manufacture of the corset shown in the photograph of FIG. 5 will be described. The starting material was a vegetable tanned animal hide measuring approximately 30 centimeters (“cm”) in width, approximately 60 cm in length, 3 mm in thickness and approximately 1.2 oz in weight. The vegetable tan hide side of the cowhide was wetted and soaked with water using a sponge. The water temperature was at ambient room temperature. The vegetable tan hide side was wetted for a period of approximately 20 minutes in order to absorb the water and soak the hide. Once the vegetable tan hide side absorbed the water, the vegetable tan hide side was chemically treated with Star Bright® Liquid II Sizing commercially available from Faultless Starch Company of Kansas City, Mo. The liquid sizing was applied for approximately 2 minutes to the wetted vegetable tan hide side using a soft bristle brush. After approximately 2 minutes, the cowhide became sufficiently flexible and malleable in order to shape. The flexible, malleable cowhide was draped onto the torso of a mannequin and held in place firmly using 2 inch steel pins. As the chemically treated cowhide was being shaped into a corset on the mannequin torso, semi-dry and substantially dry areas began forming after approximately 5 to 7 minutes. The semi-dry and substantially dry areas of the cowhide were being re-wetted with water using a sponge and chemically treated again with the liquid sizing using the soft bristle brush. Once the cowhide was shaped into the desired corset form, the sculpted cowhide was set aside and allowed to dry at an ambient room temperature for twenty-four hours until the corset became stiff and hard.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A method for shaping animal hide, comprising:
wetting a natural hide side of an animal hide;
chemically treating a substantially wetted natural hide side of said animal hide; and
shaping said animal hide.

2. The method of claim 1, further comprising wetting and chemically treating a semi-dry area or a substantially dry area of said natural hide side of said animal hide.

3. The method of claim 1, wherein wetting comprises applying a solution substantially comprising water to said natural hide side.

4. The method of claim 3, wherein applying comprises a method selected from the group consisting of brushing, sponging, wiping, rubbing, pouring, toweling, swabbing, scrubbing, spraying, squirting, dripping, dipping and smearing.

5. The method of claim 3, wherein said solution is water.

6. The method of claim 1, wherein chemically treating comprises applying a substantially chemical based solution to said substantially wetted natural hide side.

7. The method of claim 6, wherein applying comprises a method selected from the group consisting of brushing, sponging, wiping, rubbing, pouring, toweling, swabbing, scrubbing, spraying, squirting, dripping and smearing.

8. The method of claim 6, wherein applying comprises applying evenly said substantially chemical based solution to said substantially wetted natural hide side.

9. The method of claim 6, wherein said substantially chemical based solution comprises a sizing.

10. The method of claim 9, wherein said sizing comprises a petroleum based carrier or a hydrocarbon resin based carrier.

11. The method of claim 9, wherein said sizing comprises a solution of a solid sizing in a liquid petroleum based carrier or a liquid hydrocarbon resin based carrier.

12. The method of claim 9, wherein said sizing is a liquid sizing comprising a petroleum based carrier or a hydrocarbon resin based carrier.

13. The method of claim 9, wherein said sizing is an aerosol comprising a petroleum based carrier or a hydrocarbon resin based carrier.

14. The method of claim 1, wherein said animal hide is a vegetable tanned hide or a chromium tanned hide, and said natural hide side is a vegetable tan hide side or a chromium tan hide side.

15. The method of claim 1, wherein said animal hide possesses a thickness of no more than about three millimeters.

16. The method of claim 1, wherein said animal hide possesses a thickness of about one millimeter to three millimeters.

17. The method of claim 1, wherein said animal hide possesses a thickness of no less than about three millimeters.

18. The method of claim 1, wherein said animal hide is selected from the group consisting of alligator hide, crocodile hide, deer hide, cow hide and horse hide.

19. A fashion apparel created according to the process of claim 1.

20. A work of art created according to the process of claim 1
